(19) United States
(12) Patent Application Publication
(10) Pub. No.: US 2015/0217504 A1
(43) Pub. Date: Aug. 6, 2015

(54) IMPRINT TEMPLATE AND METHOD FOR MANUFACTURING THE SAME

(71) Applicant: KABUSHIKI KAISHA TOSHIBA, Tokyo (JP)

(72) Inventors: Shinichiro Nakagawa, Yokohama-shi (JP); Masafumi Asano, Yokohama-shi (JP); Satoshi Tanaka, Kawasaki-shi (JP)

(21) Appl. No.: 14/294,766

(22) Filed: Jun. 3, 2014

(30) Foreign Application Priority Data
Feb. 4, 2014 (JP) 2014-019427

(51) Int. Cl. B29C 59/02; B29C 33/38

(52) U.S. Cl. CPC B29C 59/022; B29C 33/3842; B29C 2059/023

(57) ABSTRACT

According to one embodiment, an imprint template used for imprint includes a pattern region, a peripheral region, a region, and a first transmittance control part. The pattern region is provided with a first protrusion. The peripheral region surrounds the pattern region. The region is provided in the peripheral region and provided with a second protrusion. The first transmittance control part is provided in the peripheral region and configured to control intensity of light transmitted through the template in thickness direction. The template has a planar shape axisymmetric with respect to a line passing through center of the template. The region provided with the second protrusion and the first transmittance control part are provided at positions axisymmetric to each other with respect to the line passing through the center of the template.

### CROSS-REFERENCE TO RELATED APPLICATIONS

This application is based upon and claims the benefit of priority from Japanese Patent Application No. 2014-019427, filed on Feb. 4, 2014; the entire contents of which are incorporated herein by reference.

### FIELD

Embodiments described herein relate generally to an imprint template and a method for manufacturing the same.

### BACKGROUND

In the manufacturing of semiconductor devices, the imprint technique may be used to form a pattern. For instance, a liquid resin material is dropped on a semiconductor substrate. An imprint template (also called imprint mold) with a pattern formed therein is pressed against the resin material. The resin material is cured by irradiation with ultraviolet radiation. Thus, a transfer target part in which the pattern is transferred is formed on the semiconductor substrate.

Furthermore, an imprint template that can be released from the transfer target part has been proposed. In this imprint template, an adjustment part is provided in the peripheral region surrounding the pattern region in which a protrusion part forming the pattern is provided.

In this case, in the adjustment part, the transmittance of light decreases toward the outside of the imprint template.

Here, in order to improve productivity, the imprint template may be shifted by a prescribed distance to successively transfer the pattern.

In such cases, the imprint template is shifted so that the regions of the transfer target part opposed to the pattern region of the imprint template do not overlap each other, but the regions of the transfer target part opposed to the peripheral region overlap each other.

### BRIEF DESCRIPTION OF THE DRAWINGS

FIG. 1 is a schematic view for illustrating an imprint template 1 according to this embodiment;

FIG. 2 is a sectional view taken along line A-A in FIG. 1;

FIG. 3 is a schematic view for illustrating an alternative arrangement configuration of the transmittance control part 7;

FIGS. 4A to 4C are schematic process sectional views for illustrating transfer using an imprint template 102 according to a comparative example;

FIG. 5 is a schematic plan view for illustrating curing using the imprint template 1;

FIG. 6 is a schematic view for illustrating an imprint template 21 according to an alternative embodiment; and

FIGS. 7A to 7C and 8A to 8C are schematic process sectional views for illustrating the method for manufacturing an imprint template according to this embodiment.

### DETAILED DESCRIPTION

In general, according to one embodiment, an imprint template used for imprint includes a pattern region, a peripheral region, a region, and a first transmittance control part. The pattern region is provided with a first protrusion. The peripheral region surrounds the pattern region. The region is provided in the peripheral region and provided with a second protrusion. The first transmittance control part is provided in the peripheral region and configured to control intensity of light transmitted through the template in thickness direction. The template has a planar shape axisymmetric with respect to a line passing through center of the template. The region provided with the second protrusion and the first transmittance control part are provided at positions axisymmetric to each other with respect to the line passing through the center of the template.

Embodiments will now be illustrated with reference to the drawings. In the drawings, similar components are labeled with like reference numerals, and the detailed description thereof is omitted appropriately.

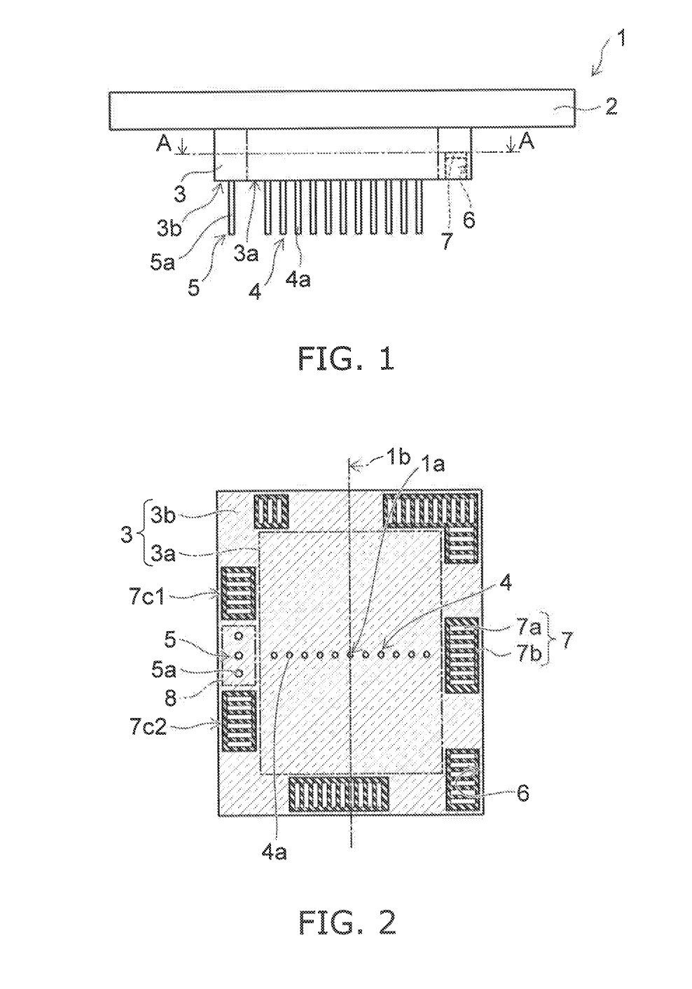

FIG. 1 is a schematic view for illustrating an imprint template 1 according to this embodiment.

FIG. 2 is a sectional view taken along line A-A in FIG. 1.

Here, FIG. 2 is a sectional view of the mesa part 3.

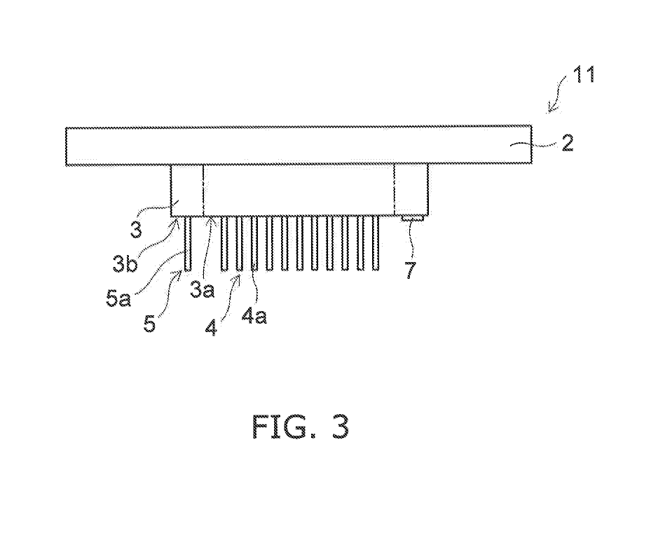

FIG. 3 is a schematic view for illustrating an alternative arrangement configuration of the transmittance control part 7.

As shown in FIGS. 1 and 2, the imprint template 1 includes a base part 2, a mesa part 3, a pattern part 4, a mark pattern part 5, a recess 6, and a transmittance control part 7 (corresponding to an example of the first transmittance control part).

The base part 2 is shaped like a flat plate. When the imprint template 1 is attached to an imprint apparatus, the base part 2 is held by the imprint apparatus.

The mesa part 3 is projected from the base part 2. The cross-sectional area of the mesa part 3 in the direction orthogonal to the thickness direction is smaller than the cross-sectional area of the base part 2 in the direction orthogonal to the thickness direction.

The imprint template 1 has a planar shape axisymmetric with respect to the line 1b passing through the center 1a of the imprint template 1.

For instance, the planar shape of the base part 2 can be made nearly rectangular.

As shown in FIG. 2, the planar shape of the mesa part 3 can be made nearly rectangular.

If the planar shape of the mesa part 3 is nearly rectangular, the shape of the cured region formed in a transfer target part 100 is also made nearly rectangular. This can improve the space efficiency in performing transfer.

The mesa part 3 includes a pattern region 3a and a peripheral region 3b. The pattern region 3a is provided on the center side of the mesa part 3. The peripheral region 3b is provided so as to surround the pattern region 3a. The peripheral region 3b is configured so as to be located on the scribe line (dicing line) of the semiconductor substrate (wafer) 101 when performing transfer.

The planar shape of the pattern region 3a can be made e.g. nearly rectangular.

The planar shape of the peripheral region 3b can be shaped like e.g. a nearly rectangular frame.

Here, the base part 2 is not necessarily needed. When the imprint template 1 is attached to the imprint apparatus, the mesa part 3 may be held by the imprint apparatus.

However, the mesa part 3 projected from the base part 2 serving as a holding part can be provided. This can suppress that the portion other than the pattern part 4 and the mark pattern part 5 is in contact with the transfer target part 100 even if the imprint template 1 is inclined when performing transfer.

Here, imprint templates include a master template and a replica template.

The master template is a template for creating a replica template. The replica template is used in transferring a pattern to a transfer target part 100.

Repetitive transfer of the pattern gradually damages the pattern part 4 and the mark pattern part 5. Thus, it is preferable to use the master template to create a plurality of replica templates, which are consumables.

The master template is created by e.g. forming a pattern part and a mark pattern part on a flat plate-like substrate using the electron beam writing technique. Typically, a single master template is created.

The replica template is created by e.g. transferring the pattern part 4 and the mark pattern part 5 to the mesa part 3 projected from the base part 2 using the master template.

In this case, the inclination of the master template with respect to the replica template is small. Thus, in the master template, contact at the time of transfer does not need to be taken into consideration. Accordingly, the master template does not need to have a mesa structure projected from a flat plate-like substrate.

The imprint template 1 according to this embodiment can be e.g. a replica template.

The pattern part 4 is provided in the pattern region 3a. The pattern part 4 can be configured to include e.g. a plurality of protrusions 4a (corresponding to an example of the first protrusion) projected from the mesa part 3. By the protrusions 4a pressed against the transfer target part 100, a desired pattern (such as a circuit pattern of a semiconductor device) is transferred to the transfer target part 100.

The configuration of the pattern part 4 is not limited to e.g. the shape of the protrusion 4a, the arrangement of the protrusions 4a, and the number of protrusions 4a illustrated above. The configuration of the pattern part 4 can be appropriately modified in accordance with the pattern transferred to the transfer target part 100.

The mark pattern part 5 is provided in a mark region 8 located in the peripheral region 3b. The mark pattern part 5 can be configured to include e.g. a plurality of protrusions 5a (corresponding to an example of the second protrusion) projected from the mesa part 3. That is, the mark region 8 is a region provided in the peripheral region 3b and provided with the protrusions 5a.

By the protrusions 5a pressed against the transfer target part 100, a desired mark (such as an alignment mark) is transferred to the transfer target part 100.

For instance, the alignment mark is used to rectify the misalignment between the semiconductor substrate 101 and the imprint template 1.

The configuration of the mark pattern part 5 is not limited to e.g. the shape of the protrusion 5a, the arrangement of the protrusions 5a, and the number of protrusions 5a illustrated above. The configuration of the mark pattern part 5 can be appropriately modified in accordance with the mark transferred to the transfer target part 100.

The mark transferred to the transfer target part 100 is not limited to the alignment mark, but can be appropriately modified.

The recess 6 is provided in the peripheral region 3b of the mesa part 3. The recess 6 is opened to the surface of the mesa part 3 on the side where the protrusion 5a is projected.

The transmittance control part 7 is provided on the bottom surface of the recess 6.

Here, the recess 6 is not necessarily needed.

For instance, as in the imprint template 11 illustrated in FIG. 3, the transmittance control part 7 may be provided on the surface of the mesa part 3 on the side where the protrusion 5a is projected.

In this case, the thickness dimension of the transmittance control part 7 is shorter than the height dimension of the protrusion 4a and the protrusion 5a.

However, if the transmittance control part 7 is provided on the bottom surface of the recess 6, contact between the transmittance control part 7 and the transfer target part 100 at the time of transfer can be suppressed. This can suppress peeling of the transmittance control part 7 and fouling of the transmittance control part 7 and the transfer target part 100.

The transmittance control part 7 controls the intensity of light (e.g., ultraviolet radiation) transmitted through the imprint template 1 in the thickness direction. The transmittance control part 7 controls the degree of curing in the corresponding region of the transfer target part 100 by controlling the intensity of transmitted light.

The transmittance control part 7 can be configured to have a pattern not transferred to the transfer target part 100 and repeating a simple shape.

For instance, the transmittance control part 7 can be configured to include a film-like light blocking part 7b and a plurality of equally spaced light transmitting parts 7a penetrating through the light blocking part 7b. In this case, the intensity of transmitted light can be controlled by e.g. the opening area and the number of the light transmitting parts 7a.

Alternatively, the intensity of transmitted light can be controlled by changing the thickness dimension of the light blocking part 7b without providing the light transmitting parts 7a.

The light blocking part 7b can be a film based on chromium, a film based on chromium nitride, a film based on chromium oxide, or a laminated film of a combination thereof.

Alternatively, the transmittance control part 7 can be formed by ion implantation into the surface of the mesa part 3 or the bottom surface of the recess 6. That is, the transmittance control part 7 can be configured to include ion-implanted ions.

The transmittance control part 7 and the mark region 8 are provided at positions axisymmetric to each other with respect to the line 1b passing through the center 1a of the imprint template 1.

The outer shape of the transmittance control part 7 is larger than the outer shape of the mark region 8.

In the case where a plurality of transmittance control parts 7 are provided in the portion opposed to the peripheral region 3b across the line 1b, the plurality of transmittance control parts 7 are provided at positions not axisymmetric to each other with respect to the line 1b.

For instance, the transmittance control part 7 is provided at a position not axisymmetric to the transmittance control part 7c1 and the transmittance control part 7c2 with respect to the line 1b.

The base part 2, the mesa part 3, the protrusion 4a, and the protrusion 5a can be integrally formed. The base part 2, the mesa part 3, the protrusion 4a, and the protrusion 5a can be formed from a material transmitting ultraviolet radiation such as quartz.

Next, the arrangement of the transmittance control part 7 and the arrangement of the mark region 8 are further described.

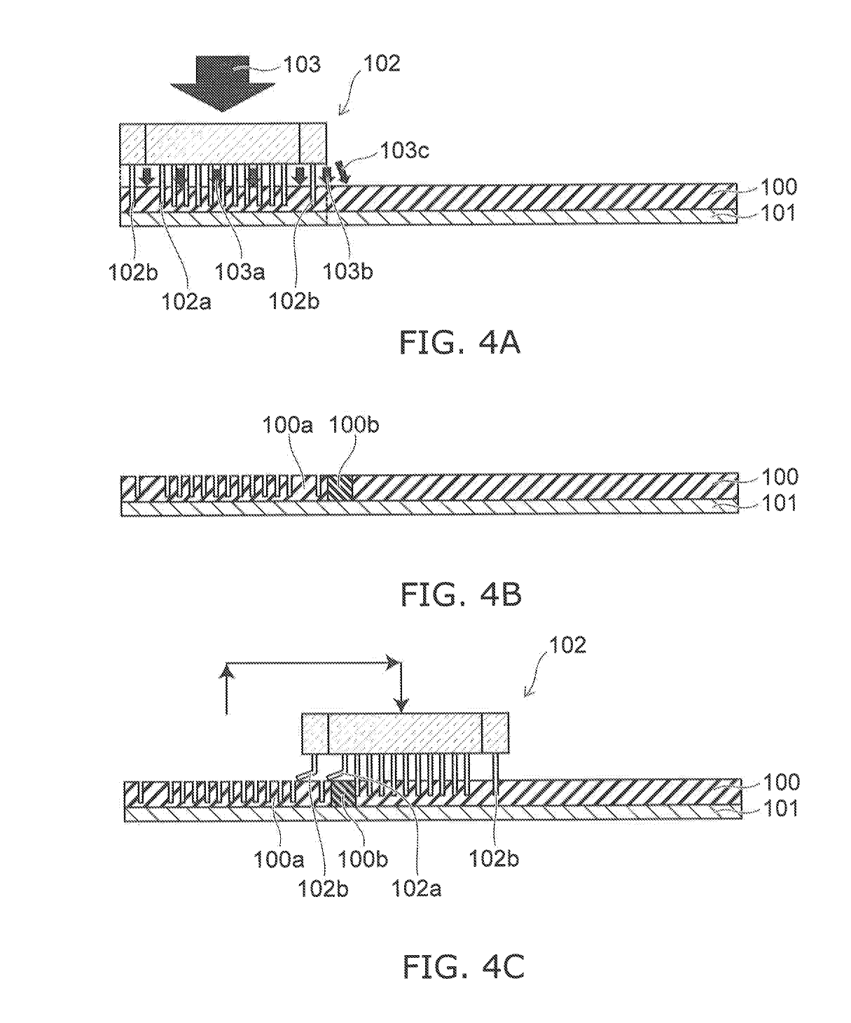

FIGS. 4A to 4C are schematic process sectional views for illustrating transfer using an imprint template 102 according to a comparative example.

As shown in FIG. 4A, like the imprint template 1 described above, the imprint template 102 includes a protrusion 102a provided in the pattern region and a protrusion 102b provided in the peripheral region.

However, unlike the imprint template 1 described above, the imprint template 102 does not include the transmittance control part 7.

First, as shown in FIG. 4A, by the imprint apparatus, the imprint template 102 is pressed against a transfer target part 100 provided on a semiconductor substrate 101.

At this time, the transfer target part 100 is in a pre-cured (e.g., liquid) state. Thus, the protrusion 102a and the protrusion 102b are inserted into the transfer target part 100.

Subsequently, the transfer target part 100 is irradiated with ultraviolet radiation 103 through the imprint template 102.

At this time, the ultraviolet radiation 103a transmitted through the pattern region is applied to the region of the transfer target part 100 where the pattern is to be transferred.

The ultraviolet radiation 103b transmitted through the peripheral region is applied to the surroundings of the region of the transfer target part 100 where the pattern is to be transferred.

The ultraviolet radiation 103c transmitted through the side surface of the imprint template 102 is applied to the surroundings of the region of the transfer target part 100 irradiated with the ultraviolet radiation 103b.

Here, the transfer target part 100 includes an ultraviolet curable resin.

Thus, as shown in FIG. 4B, the region of the transfer target part 100 irradiated with the ultraviolet radiation 103a-103c is cured.

Here, the intensity of the ultraviolet radiation 103a and the intensity of the ultraviolet radiation 103b are nearly comparable.

Thus, in the transfer target part 100, the region irradiated with the ultraviolet radiation 103a and the region irradiated with the ultraviolet radiation 103b are cured into a cured part 100a.

The region of the transfer target part 100 irradiated with the ultraviolet radiation 103c is cured into a cured part 100b.

In this case, the intensity of the ultraviolet radiation 103c is lower than the intensity of the ultraviolet radiation 103a or the intensity of the ultraviolet radiation 103b.

Thus, the cured part 100b is softer than the cured part 100a. However, the cured part 100b is harder than the pre-cured transfer target part 100.

Next, transfer of a pattern is successively performed.

First, by the imprint apparatus, the imprint template 102 is raised and shifted by a prescribed distance.

Next, as shown in FIG. 4C, by the imprint apparatus, the imprint template 102 is pressed against the transfer target part 100.

Here, the region irradiated with the ultraviolet radiation 103b (the region opposed to the peripheral region of the imprint template 102) is located on the scribe line of the semiconductor substrate 101. That is, the region of the semiconductor substrate 101 opposed to the region irradiated with the ultraviolet radiation 103b is a region to be removed when singulating the semiconductor device.

Thus, the space efficiency can be improved if the adjacent regions irradiated with the ultraviolet radiation 103b are configured to overlap each other.

However, a mark such as an alignment mark is formed in the region irradiated with the ultraviolet radiation 103b.

Thus, if the adjacent regions irradiated with the ultraviolet radiation 103b are configured to overlap each other, the protrusion 102b is pressed against the cured part 100a. This may damage the protrusion 102b.

Furthermore, the protrusion 102a is pressed against the cured part 100b. This may damage the protrusion 102a.

Even if there is no damage to the protrusion 102a and the protrusion 102b, transfer failure may occur.

In this case, damage and transfer failure of the protrusion 102a and the protrusion 102b can be suppressed by preventing the adjacent regions irradiated with the ultraviolet radiation 103b from overlapping each other. However, the space efficiency is then deteriorated.

FIG. 5 is a schematic plan view for illustrating curing using the imprint template 1.

The imprint template 1 according to this embodiment includes a transmittance control part 7. Thus, curing is suppressed in the region 100c of the transfer target part 100 opposed to the transmittance control part 7.

On the other hand, the region 100d of the transfer target part 100 opposed to the region not provided with the transmittance control part 7 is cured. A circuit pattern 104 and an alignment mark 105 are transferred thereto. The circuit pattern 104 is transferred to the region 105 opposed to the pattern region 3a.

The alignment mark 105 is transferred to the region 106 opposed to the mark region 8.

Here, the transmittance control part 7 and the mark region 8 are provided at positions axisymmetric to each other with respect to the line 1b passing through the center 1a of the imprint template 1.

Curing is suppressed in the region of the transfer target part 100 opposed to the transmittance control part 7. Thus, when performing transfer in the adjacent regions, the protrusion 5a can be pressed against the region where curing is suppressed by the transmittance control part 7. As a result, damage to the protrusion 5a and transfer failure can be suppressed.

In the case where a plurality of transmittance control parts 7 are provided in the portion opposed to the peripheral region 3b across the line 1b, the plurality of transmittance control parts 7 are provided at positions not axisymmetric to each other with respect to the line 1b.

For instance, the transmittance control part 7 is provided at a position not axisymmetric to the transmittance control part 7c1 and the transmittance control part 7c2 with respect to the line 1b.

Thus, the region of the transfer target part 100 opposed to the portion opposed to the peripheral region 3b across the line 1b can be gradually cured.

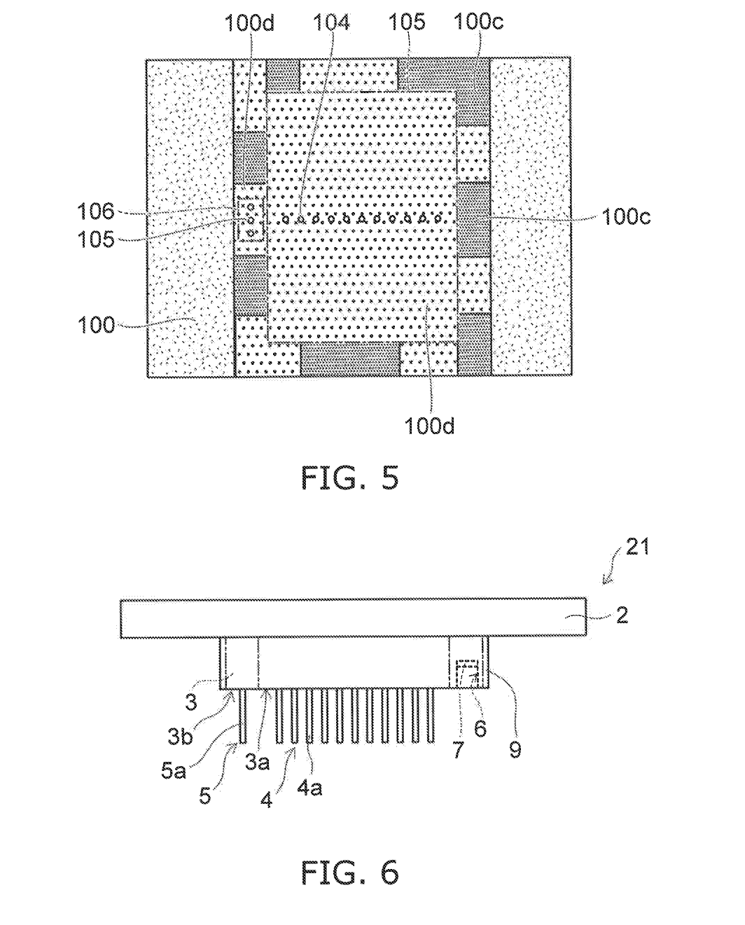

FIG. 6 is a schematic view for illustrating an imprint template 21 according to an alternative embodiment.

As shown in FIG. 6, like the imprint template 1, the imprint template 21 includes a base part 2, a mesa part 3, a pattern part 4, a mark pattern part 5, a recess 6, and a transmittance control part 7.

The imprint template 21 further includes a transmittance control part 9 (corresponding to an example of the second transmittance control part).

The transmittance control part 9 is provided so as to cover the side surface of the mesa part 3.

The material and configuration of the transmittance control part 9 can be made similar to the material and configuration of the transmittance control part 7 described above.

The transmittance control part 9 thus provided can suppress the occurrence of ultraviolet radiation 103c transmitted through the side surface of the imprint template 21 illustrated in FIG. 4A.

This can further suppress unintended curing in the transfer target part 100.

Next, a method for manufacturing an imprint template according to this embodiment is described.

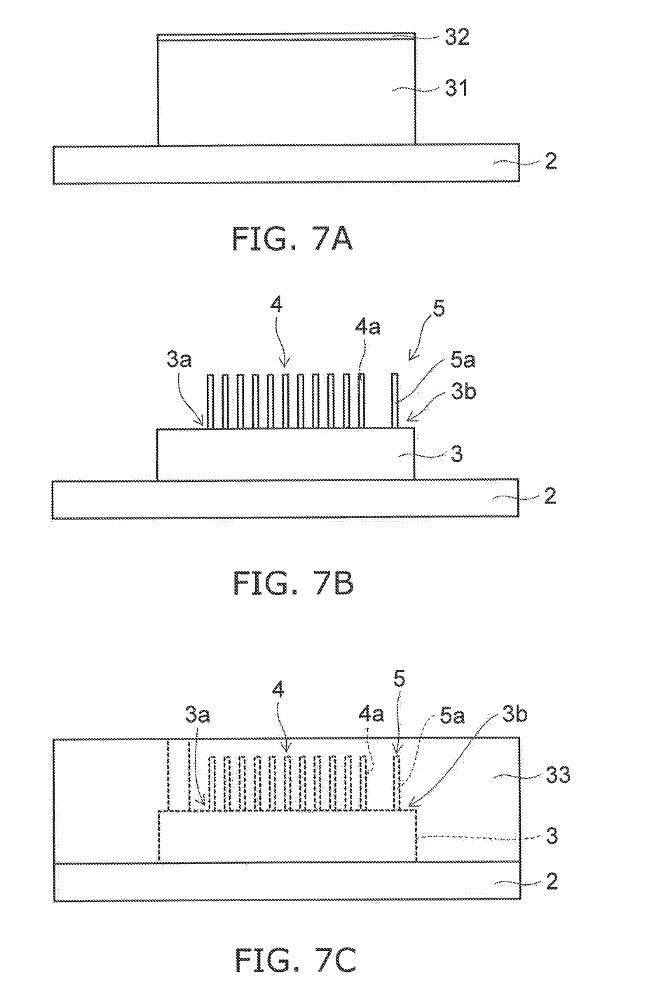

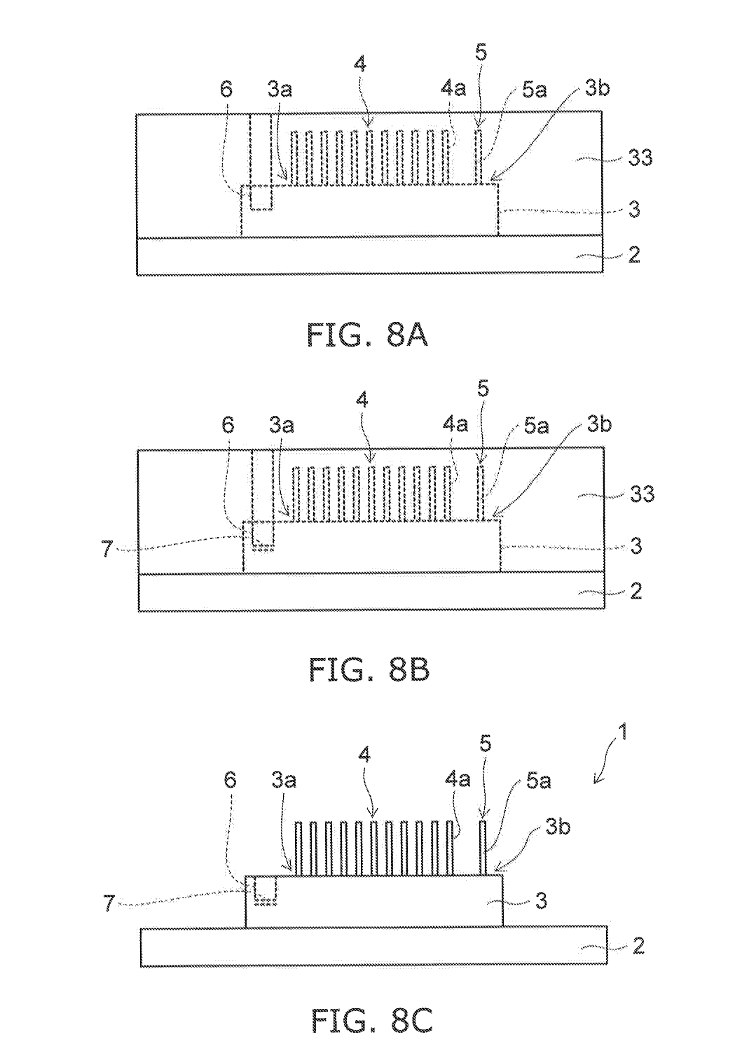

FIGS. 7A to 7C and 8A to 8C are schematic process sectional views for illustrating the method for manufacturing an imprint template according to this embodiment.

First, as shown in FIG. 7A, a flat plate-like blank based on e.g. quartz is cut to form a base part 2 and a protruding part 31.

The protruding part 31 constitutes a portion in which a mesa part 3, a pattern part 4, and a mark pattern part 5 are formed.

Subsequently, a film 32 based on chromium nitride is formed on the protruding part 31.

The film 32 is a film constituting a hard mask used to form a protrusion 4a and a protrusion 5a.

Subsequently, an ultraviolet curable resin is applied so as to cover the base part 2 and the protruding part 31.

Subsequently, a master template is pressed against the ultraviolet curable resin formed on the protruding part 31. By pressing the master template, the ultraviolet curable resin is deformed following the feature formed in the master template.

Subsequently, with the master template being pressed, irradiation with ultraviolet radiation is performed through the master template. Then, the ultraviolet curable resin is cured. Thus, an etching mask having a desired pattern is formed on the protruding part 31.

Subsequently, the master template is detached from the ultraviolet curable resin.

Subsequently, dry etching processing is performed using the etching mask formed on the protruding part 31. Thus, a hard mask is formed.

The dry etching processing can be e.g. plasma etching processing using an etching gas including chlorine.

Subsequently, the ultraviolet curable resin is removed by dry ashing processing or wet ashing processing.

Subsequently, dry etching processing is performed using the hard mask formed on the protruding part 31. Thus, a mesa part 3, a protrusion 4a, and a protrusion 5a are formed.

The dry etching processing can be e.g. plasma etching processing using an etching gas including fluorine.

Next, the hard mask is removed.

Thus, as shown in FIG. 7B, a pattern part 4 including a plurality of protrusions 4a in the pattern region 3a of the mesa part 3, and a mark pattern part 5 including a plurality of protrusions 5a in the peripheral region 3b of the mesa part 3 can be formed.

The removal of the hard mask can be performed by e.g. wet etching processing using cerium nitrate.

Next, as shown in FIG. 7C, an ultraviolet curable resin 33 is applied so as to cover the base part 2, the mesa part 3, the pattern part 4, and the mask pattern part 5.

Subsequently, part of the ultraviolet curable resin 33 is selectively removed to form an etching mask. Next, as shown in FIG. 8A, dry etching processing is performed using the formed etching mask. Thus, a recess 6 is formed.

Next, as shown in FIG. 8B, a transmittance control part 7 is formed on the bottom surface of the recess 6.

The transmittance control part 7 can be formed by using e.g. CVD (chemical vapor deposition) technique and the like.

Furthermore, a plurality of light transmitting parts 7a penetrating through a light blocking part 7b can be formed by selectively removing the light blocking part 7b.

Alternatively, the transmittance control part 7 can be formed by performing ion implantation.

Here, the recess 6 can also be formed by etching processing using a hard mask.

Next, as shown in FIG. 8C, the ultraviolet curable resin 33 is removed.

As described above, the imprint template 1 can be manufactured.

In the case of forming the imprint template 11, formation of the recess 6 is omitted. A transmittance control part 7 is formed on the surface of the mesa part 3 on the side where the protrusion 5a is projected.

In the case of forming the imprint template 21, a transmittance control part 9 is formed so as to cover the side surface of the mesa part 3.

Formation of the transmittance control part 9 can be made similar to that of the transmittance control part 7.

As described above, this embodiment can provide an imprint template capable of performing appropriate transfer and a method for manufacturing the same.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Moreover, above-mentioned embodiments can be combined mutually and can be carried out.

1. An imprint template used for imprint, comprising:
a pattern region provided with a first protrusion;
a peripheral region surrounding the pattern region;
a region provided in the peripheral region and provided with a second protrusion; and
a first transmittance control part provided in the peripheral region and configured to control intensity of light transmitted through the template in thickness direction,
the template having a planar shape axisymmetric with respect to a line passing through center of the template, and
the region provided with the second protrusion and the first transmittance control part being provided at positions axisymmetric to each other with respect to the line passing through the center of the template.

2. The template according to claim 1, wherein thickness dimension of the first transmittance control part is shorter than height dimension of the first protrusion and the second protrusion.

3. The template according to claim 1, wherein the first transmittance control part has a pattern not transferred to a transfer target part provided on a semiconductor substrate and repeating a simple shape.

4. The template according to claim 1, further comprising:
a recess opened to the peripheral region,
wherein the first transmittance control part includes a light blocking part provided on a bottom surface of the recess and a light transmitting part penetrating through the light blocking part.

5. The template according to claim 4, the light blocking part is at least one of a film based on chromium, a film based on chromium nitride, a film based on chromium oxide, and a laminated film of a combination thereof.

6. The template according to claim 1, wherein the first transmittance control part includes ion-implanted ions.

7. The template according to claim 1, wherein planar shape of the template is rectangular.

8. The template according to claim 1, wherein planar shape of the pattern region is rectangular.

9. The template according to claim 1, wherein the template is a replica template.

10. The template according to claim 1, wherein outer shape of the first transmittance control part is larger than outer shape of the region provided with the second protrusion.

11. The template according to claim 1, wherein
the first transmittance control part is provided in a plurality, and
the plurality of first transmittance control parts are provided at positions not axisymmetric to each other with respect to the line passing through the center of the template.

12. The template according to claim 1, further comprising:
a base part; and
a mesa part projected from the base part and having a rectangular planar shape,
wherein the pattern region and the peripheral region are provided on a surface of the mesa part on opposite side from the base part side.

13. The template according to claim 12, further comprising:
a second transmittance control part provided on a sidewall of the mesa part.

14. The template according to claim 1, wherein the first protrusion transfers a circuit pattern to a transfer target part.

15. The template according to claim 1, wherein the second protrusion transfers a mark to a transfer target part.

16. A method for manufacturing an imprint template used for imprint, comprising:
forming a first protrusion in a pattern region, and forming a second protrusion in a region provided in a peripheral region surrounding the pattern region; and
forming a first transmittance control part in the peripheral region, the first transmittance control part being configured to control intensity of light transmitted through the template in thickness direction,
the template having a planar shape axisymmetric with respect to a line passing through center of the template, and
the region provided with the second protrusion and the first transmittance control part being provided at positions axisymmetric to each other with respect to the line passing through the center of the template.

17. The method according to claim 16, wherein the forming a first transmittance control part includes forming the first transmittance control part by ion implantation.

18. The method according to claim 16, wherein the forming a first transmittance control part includes forming a recess opened to the peripheral region and forming the first transmittance control part on a bottom surface of the recess.

19. The method according to claim 16, wherein the forming a first transmittance control part includes forming a plurality of light transmitting parts penetrating through a light blocking part by selectively removing the light blocking part.

20. The method according to claim 16, wherein the forming a first transmittance control part includes forming the first transmittance control part having a thickness dimension shorter than height dimension of the first protrusion and the second protrusion.
